(19) United States
(12) Patent Application Publication
(10) Pub. No.: US 2016/0294424 A1
(43) Pub. Date: Oct. 6, 2016

(54) DIGITAL AND ANALOG FILTERING SCHEMA

(71) Applicant: GainSpan Corporation, San Jose, CA (US)

(72) Inventors: Lewis E. ADAMS, III, San Jose, CA (US); Pankaj VYAS, San Jose, CA (US); Alan J. HERRING, San Jose, CA (US); Gregory WINNER, San Jose, CA (US)

(21) Appl. No.: 14/676,765

(22) Filed: Apr. 1, 2015

(51) Int. Cl. H04B 1/12; H04W 76/02

(52) U.S. Cl. CPC H04B 1/12; H04W 76/02

(57) ABSTRACT

A method for wireless communication includes communicating with a first wireless device via a first wireless communication protocol selected from multiple wireless communication protocols. The method also includes communicating with a wireless network via a second wireless communication protocol selected from multiple wireless communication protocols. The communications via the first wireless communication protocol and the second wireless communication protocol are filtered via a digital filter and/or an analog filter.

### TECHNICAL FIELD

The present disclosure generally relates to wireless systems. More specifically, the present disclosure relates to digital and analog filtering schema.

### BACKGROUND

For wireless systems or devices, it is desirable to improve data transfer rates while conserving power. Wireless communication protocols such as ZigBee, Bluetooth and WiFi (e.g., 80.211 WiFi) may be used for different applications. However, certain protocols such as ZigBee or Bluetooth are more suited for low bandwidth, close-range communications with devices that may not require a network, whereas other protocols such as WiFi may be better suited for high bandwidth, long-range communications with devices in a large and broad network.

Furthermore, some wireless communication protocols may consume more power in comparison to other wireless communication protocols. A given wireless communication protocol is ideally used when it communicates with a device within its target range. For instance, it is desirable to use ZigBee and Bluetooth for devices located at a closer range. Additionally, it is desirable to use WiFi for devices located farther away and/or devices that have specified an increased throughput. In addition, if a wireless communication protocol does not need to be turned on and/or does not have to send continuous messages, it is desirable to conserve power by turning off the wireless communication protocol when it is not in use.

Some conventional devices, such as remote controls, may send messages to a device to control the functionality of the device. For example, a remote control may be used the device on or off. The conventional devices use wireless communication protocols to send and receive messages. However, the conventional devices may be left on for excessive periods of time. Furthermore, the conventional devices may not use wireless communication protocol that improve interactions with other devices. Therefore, it is desirable to manage the use of wireless devices to conserve power while improving communications via wireless communications.

### SUMMARY

In one aspect of the present disclosure, a method of wireless communication is disclosed. The method includes communicating with a first wireless device via a first wireless communication protocol selected from multiple wireless communication protocols. The method also includes communicating with a wireless network via a second wireless communication protocol selected from multiple wireless communication protocols. The communications via the first wireless communication protocol and the second wireless communication protocol being filtered via a digital filter and/or an analog filter. The method further includes selecting a wireless protocol from the multiple wireless communication protocols for either the first wireless communication protocol or the second wireless communication protocol based on specific criteria.

In another aspect of the present disclosure, a wireless system is disclosed. The wireless system includes a first wireless device and a second wireless device connected to the first wireless device via a first wireless communication protocol selected from multiple wireless communication protocols. The second wireless device includes a digital filter and an analog filter. The wireless system also includes a wireless network connected to the device via a second wireless communication protocol selected from multiple wireless communication protocols. Additionally, second wireless device selects a wireless protocol from the multiple wireless communication protocols for either the first wireless communication protocol or the second wireless communication protocol based on specific criteria

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a schematic diagram of a device using various wireless communication protocols according to an aspect of the present disclosure.

FIG. 2 is a schematic diagram of a device in communication with a remote control and using various wireless communication protocols according to an aspect of the present disclosure.

FIG. 3 is a schematic diagram of a device in communication with a remote control and using various wireless communication protocols according to an aspect of the present disclosure.

FIG. 4 is a schematic diagram of a device in communication with a remote control and using various wireless communication protocols according to an aspect of the present disclosure.

FIG. 5 is a schematic diagram of a device in communication with a remote control and using various wireless communication protocols according to an aspect of the present disclosure.

FIG. 6 is a process flow diagram illustrating a method of using a remote control to communicate with a device using various wireless communication protocols, according to an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

Aspects of the present disclosure are related to wireless systems that use a remote control to communicate with a device via a wireless communication protocol (such as ZigBee, Bluetooth, or WiFi). The wireless communication protocols may or may not use a wireless network. For example, some wireless communication protocols, such as ZigBee or Bluetooth, do not use a pre-established wireless network. Rather, the a first wireless device, such as a remote control, communicates with a second wireless device in a bidirectional or unidirectional fashion. For other wireless communication protocols, such as 802.11 WiFi, a pre-established wireless network is used so that a first wireless device, such as the remote control, can communicate with a second wireless device using long range communications. In the present application, wireless communication protocols may sometimes be referred to as wireless protocols.

In one configuration, information or messages can be sent from the remote control to the device via one or more wireless protocols. Still, in this configuration, a wireless protocol is selected according to various criteria. For example the wireless protocol may be determined based on a distance between the transmitter and the receivers and/or particular application. Furthermore, the wireless protocol is selected to reduce power use and improve the use of resources. In addition, the device may also use a number of different wireless communication protocols to communicate with a wireless network, other devices, a cloud, and/or other entities. The different wireless communication protocols may reinforce one another. That is, in case one wireless communication protocol fails or goes down, then another wireless communication protocol is there to take its place. Specifying multiple wireless communication protocols to serve as auxiliary or parallel channels to one another improves the robustness and reliability of the overall system.

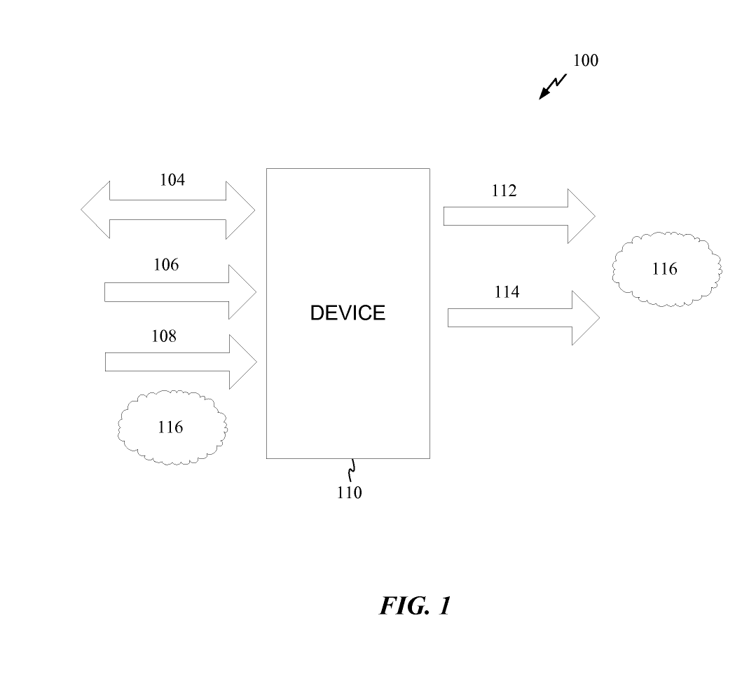

FIG. 1 is a schematic diagram of a device 110 using various wireless communication protocols according to an aspect of the present disclosure.

Device 110 may receive information or messages via bidirectional close-range protocol 104, unidirectional close-range protocol 106, or long-range protocol 108. The long-range protocol 108 may also be assisted by wireless network 116, which may include other devices, such as remote controls, and/or connections to other devices.

An example of the bidirectional close-range protocol 104 is a ZigBee or Bluetooth connection because the bidirectional close-range protocol 104 only specifies the need for the device 110 and another device (not shown) in communications with one another. That is, the bidirectional close range protocol 104 does not use a wireless network for communications. This also means that the bidirectional close range protocol 104 uses less bandwidth, less power, and less resources in comparison to a conventional wireless network protocol connection. The bidirectional close range protocol 104 also does not have congestion or traffic because it is not on a conventional wireless network and may not be bound by frequency channels regulated by the FCC.

An example of the unidirectional close-range protocol 106 is ZigBee. For instance, the device 110 may be a smartphone and a store may be broadcasting an advertisement or similar message when the device 110 is within close proximity of the store such that the device 110 is also within the necessary range for ZigBee transmissions. The unidirectional close-range protocol 106 also does specify use a wireless network to communicate with the device 110. However, to receive messages, the device 110 should be close enough to the source broadcasting information via the unidirectional close-range protocol 106. The unidirectional close-range protocol 106 also has the advantages of less bandwidth, less power consumption, little to no congestion or traffic, and not being on a frequency channel regulated by the FCC.

An example of the long-range protocol 108 is a 802.11 WiFi connection. The long-range protocol 108 may use the wireless network 116. For instance, the device 110 may be a smartphone and a store located far away from the device 110 (but in the same mall where the device 110 is present) could be broadcasting an advertisement. By using the wireless network 116, the advertisement broadcasted by that store will reach the device 110 via the long-range protocol 108.

However, the long-range protocol 108 compared to the close-range protocols of 104 and 106 may use more power, more resources, more bandwidth, and have frequency channels that may be regulated by the FCC. As a result, there are restrictions and costs associated with bandwidth usage over a wireless network 116 via long-range protocol 108. Therefore, the long-range protocol 108 should be used in certain cases—such as for performing long-distance communications—in order to conserve resources and power.

The device 110 may also use long-range export protocol 112 and close-range export protocol 114 to communicate with the wireless network 116 or other devices, which may also be located in the wireless network 116. An example of the long-range export protocol 112 is 802.11 WiFi, as discussed above. The long-range export protocol 112 may both use the wireless network 116 as well as send information from the device 110 to the wireless network 116, or another device or receiver located within the wireless network 116.

An example of the close-range export protocol 114 is ZigBee. In this case, the ZigBee connection would not use the wireless network 116 due to the nature of a ZigBee connection. Still, the device 110 may communicate with another device within the wireless network 116 via the close-range export protocol 114. For example, the device 110 may be transmitting information to another smartphone or device. As another example, there may be a receiver in a store in the wireless network 116 that receives confirmation of user participation with regards to its advertisements.

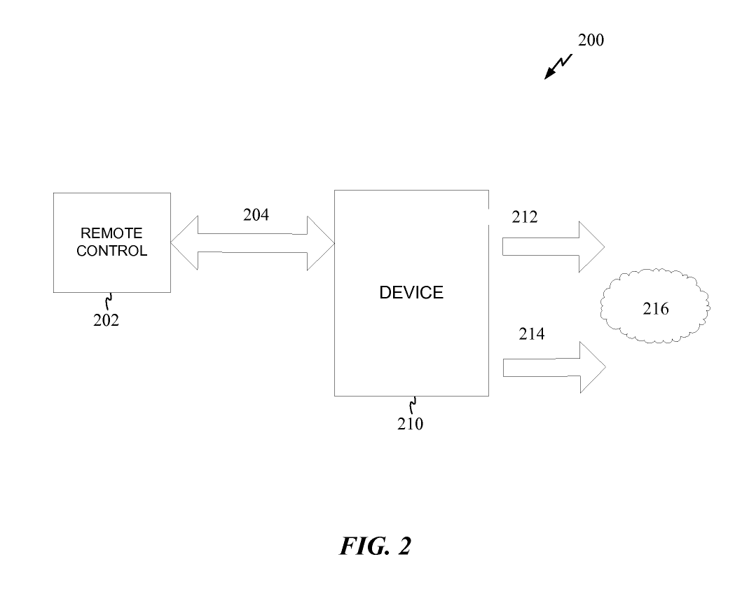

FIG. 2 is a schematic diagram 200 of a device 210 in communication with a remote control 202 and using various wireless communication protocols according to an aspect of the present disclosure.

The remote control 202 can send information and messages to device 210 via a bidirectional close-range protocol 204. An example of the bidirectional close-range protocol 204 is a ZigBee or Bluetooth connection. According to aspects of the present disclosure, the bidirectional close-range protocol 204 specifies that the remote control 202 and the device 210 to directly communicate with one another. In other words, a wireless network is not necessary. Therefore, the communications between the remote control 202 and the device 210 may have an increased speed, reduced power, and reduced bandwidth in comparison to conventional communication protocols. Furthermore, FCC requirements or regulations may not be specified for the bidirectional close-range protocol 204.

Furthermore, resources may be used because the communications are made at a relatively close range. As an example, if a device 210, such as a camera, and the remote control 202 were within a given proximity and also if the remote control 202 was configured to send the device 210 instructions such as turning on or off, and/or when to capture images. The bidirectional close-range protocol 204 may be specified to transmit a message via Zigbee from the remote control 202 to the device 210. Furthermore, the device 210 transmits an acknowledgment (ACK) message to the remote control 202 in response to receiving the message.

The device 210 may also use the long-range export protocol 212 and the close-range export protocol 214 to communicate with the wireless network 216 or other devices, which may also be located in the wireless network 216. An example of the long-range export protocol 212 is 802.11 WiFi. The long-range export protocol 212 may be used for communications between the wireless network 216 and the device 210 to the wireless network 216. Additionally, the long-range export protocol 212 may be used for communications between the device 210 and another device located within the wireless network 216 (not shown in FIG. 2). An example of the close-range export protocol 214 is ZigBee. In this case, the close-range export protocol 214 connection may not need to use the wireless network 216 due to the nature of a the close-range export protocol 214 connection. Still, the device 210 may communicate or send information to another device or receiver within the wireless network 216 via the close-range export protocol 214. For instance, the device 210 may be a camera sending data to a computer. In another example, the device 210 may be a smartphone that sends information to another smartphone or device.

In an aspect of the present disclosure, the device 210 may use more than one of the protocols, e.g., the bidirectional close-range protocol 104, the unidirectional close-range protocol 106, the long-range protocol 108, and/or the wireless network 116, to communicate with the remote control 202 or with other devices, in a concurrent fashion. In other words, the device 210 may use multiple communications links at the same time, or at nearly the same time, to transmit and receive messages from other devices. The protocols being used in a concurrent manner may be selected based on power requirements, data rate requirements, message length, signal strength, and/or other factors.

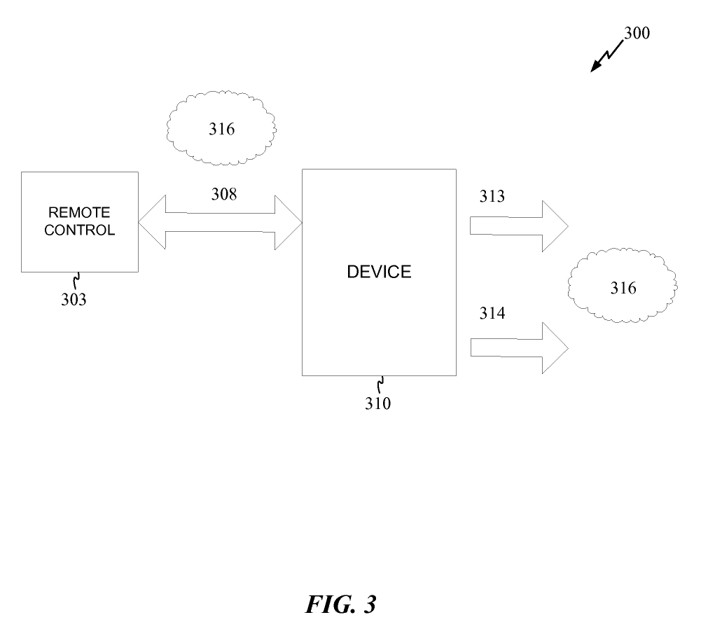

FIG. 3 is a schematic diagram 300 of a device 310 in communication with a remote control 303 and using various wireless communication protocols according to an aspect of the present disclosure.

The remote control 303 can send information and messages to device 310 via a bidirectional long-range protocol 308. An example of the bidirectional long-range protocol 308 is 802.11 WiFi. The bidirectional long-range protocol 308 would also use a wireless network 316. Communications with the bidirectional long-range protocol 308 over wireless network 316 may use increased bandwidth, power and resources. Still, it is desirable to use the bidirectional long-range protocol 308, rather than a short range protocol, for long range communications. Furthermore, the remote control 303 may access resources via the wireless network 316 that may not have been accessible via a short range protocol, such as ZigBee.

As an example, a device 310, such as a camera, may need to receive information, such as sunlight settings, from the remote control 303. In this example, the remote control 303 may access the wireless network 316 to retrieve the specified information. Therefore, it may be desirable to use a bidirectional long-range protocol 308 that has access to a wireless network 316. Likewise, in sending messages, such as ACK messages, from the device 310 to the remote control 303, the wireless network 316 can also be accessed in order to facilitate communications. For instance, the device 310, such as the a camera, may send information to the remote control 303. The information may include different turn-on/turn-off schedules. The information may be transmitted by the wireless network 316 via the bidirectional long-range protocol 308.

The device 310 also may use the long-range export protocol 313 and the close-range export protocol 314 to communicate with the wireless network 316 and/or other devices (not shown in FIG. 3) that may also be located in the wireless network 316. An example of the long-range export protocol 313 is 802.11 WiFi. An example of the close-range export protocol 314 is ZigBee.

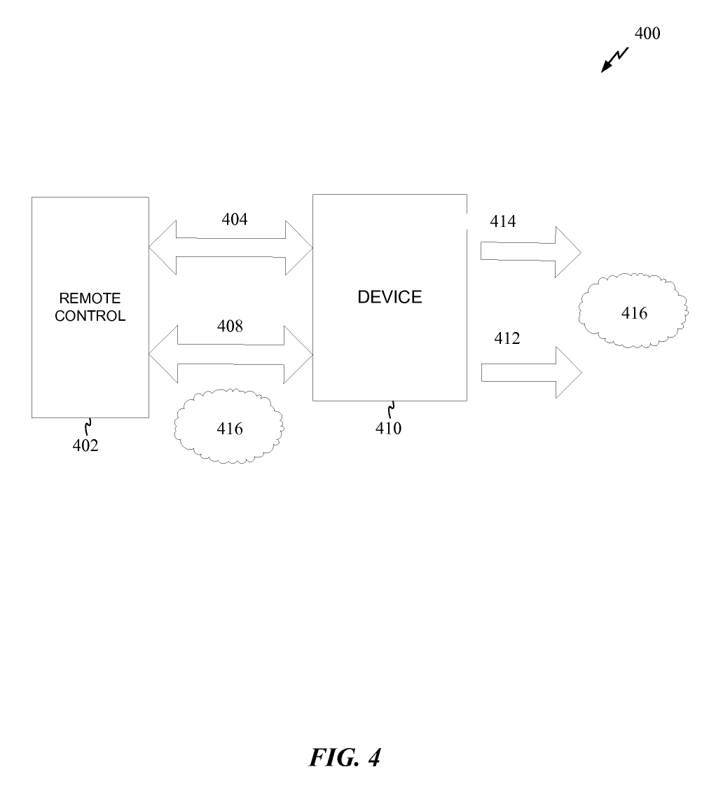

FIG. 4 is a schematic diagram 400 of a device 410 in communication with a remote control 402 according to an aspect of the present disclosure.

As shown in FIG. 4, the remote control 402, or other apparatus, may communicate with the device 410 via both a bidirectional close-range protocol 404 and a bidirectional long-range protocol 408. Both the bidirectional close-range protocol 404 and the bidirectional long-range protocol 408 are described above. In some cases, it may be desirable to simultaneously use and/or concurrently use both a bidirectional close-range protocol 404 and a bidirectional long-range protocol 408. Simultaneous transmissions may refer to messages transmitted by both protocols that use the same start and end same time. Further, concurrent transmissions may refer to messages transmitted by the protocols that do not start and/or end at the same time. Still, the messages may be transmitted at the same time over one or more wireless networks. Both simultaneous and concurrent transmission, as well as serial and/or other parallel transmission schemes, are within the scope of the present disclosure.

For example, if one of the protocols fails, another protocol may be used to transmit messages specified for the failed protocol. By using both the close-range and long-range channels as auxiliary or parallel channels, the information transfer between the remote control 402 and the device 410 is secured because of the increased redundancy of the network. Furthermore, information specified for a particular wireless communication protocol can be sent via a selected wireless communication protocol when appropriate. For example, if an increased amount of data is specified to be transmitted in a short amount of time, the bidirectional close-range protocol 404 may be used as the quickest form of transfer. Alternatively, if the amount of data is relatively small and can be sent over longer periods of time, then the bidirectional long-range protocol 408 may be used as the quickest form of transfer, with the wireless network 416 also being used to facilitate or further distribute the process.

The device 410 also may use the long-range export protocol 414 and the close-range export protocol 412 to communicate with the wireless network 416 or other devices (not shown in FIG. 4), which may also be located in the wireless network 416. An example of the long-range export protocol 414 is 802.11 WiFi. An example of the close-range export protocol 412 is ZigBee.

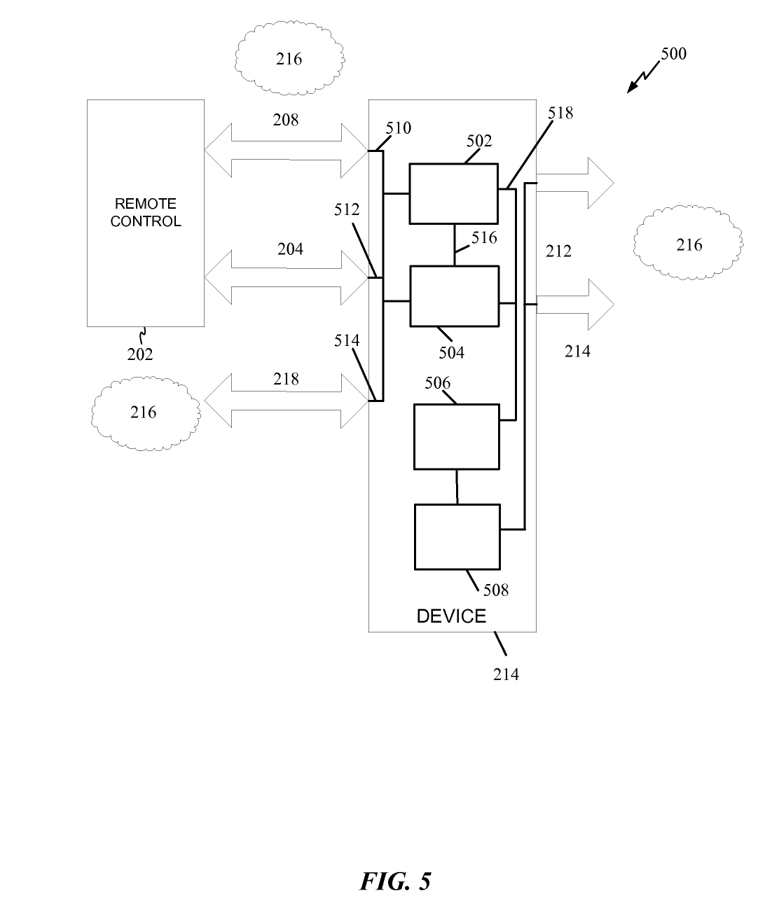

FIG. 5 is a schematic diagram 500 of a device 210 in communication with a remote control 202 according to an aspect of the present disclosure.

As shown in FIG. 5, the remote control 202 may communicate with the device 210 by a bidirectional close-range protocol 204, a bidirectional long-range protocol 208, and a long-range protocol 218. Both the bidirectional close-range protocol 204 and the bidirectional long-range protocol 208 are described above. The long-range protocol 218 may be used for communications with devices associated with the wireless network 216 as well as other devices that are within the range of the long-range protocol 218. Examples of the long-range protocol 218 include 802.11 WiFi. However, any type of long-range wireless communication protocol is contemplated.

In an aspect of the disclosure, the device 210 and/or the remote control 202 may include a digital filter 502, an analog filter 504, a processor 506, and/or a transmitter 508. Depending on the protocols used by the device 210, the digital filter 502 and/or the analog filter 504 receive the transmitted information from the remote control 202 and/or the wireless network 216. The digital filter 502 and/or the analog filter 504 provide filtering of the incoming signals 510 512 514, and one or more of the incoming signals 510-514 may be passed through both the digital filter 502 and the analog filter 504 via path 516.

The output 518 of the digital filter 502 and/or the analog filter 504 are passed to the processor 506. The processor 506 may determine, based on the output 518, which communication protocol 204 208 218 to use for communication with the remote control 502. Further, the processor 506 may also determine, based on the output 518, which communication protocols 212 214 to use for the output. The processor 506 may then indicate to the transmitter 508, which may be one or more transmitters depending on the protocol(s) selected, to transmit the appropriate output data on the selected protocol(s).

Additionally, or alternatively, the processor 506 may dynamically select or switch the protocols based on information provided by a wireless device, such as the remote 202 and/or other criteria. That is, in one configuration, the processor 506 may select a communication protocol 204 208 212 214 218 based on thresholds set by a wireless device, such as the remote 202. The thresholds may be based on data size, bandwidth size, battery levels, power consumption, and/or other criteria.

For example, the remote 208 may instruct the processor 506 to select a a communication protocol 204 208 212 214 218 based on an application that is currently running on the remote 202. As another example, the remote 208 may instruct the processor 506 to select a communication protocol 204 208 212 214 218 based on a type of action being performed by the remote 202. As yet another example, the processor 506 may select a communication protocol 204 208 212 214 218 based on the battery level of the device 210 and/or the remote 202. For example, a short-range communication protocol may be used if the battery level is less than a threshold. In another example, a long-rage communication protocol may be used if the battery level is greater than a threshold. The threshold may be set by the remote 202 or the device 210.

Further, the digital filter 502, the analog filter 504, and/or the output 518, may be used by the processor to select which of the protocol(s) to use for communication with the remote control 202. The device 210 also may use the long-range export protocol 212 and the close-range export protocol 214 to communicate with the wireless network 216 or other devices, which may also be located in the wireless network 216.

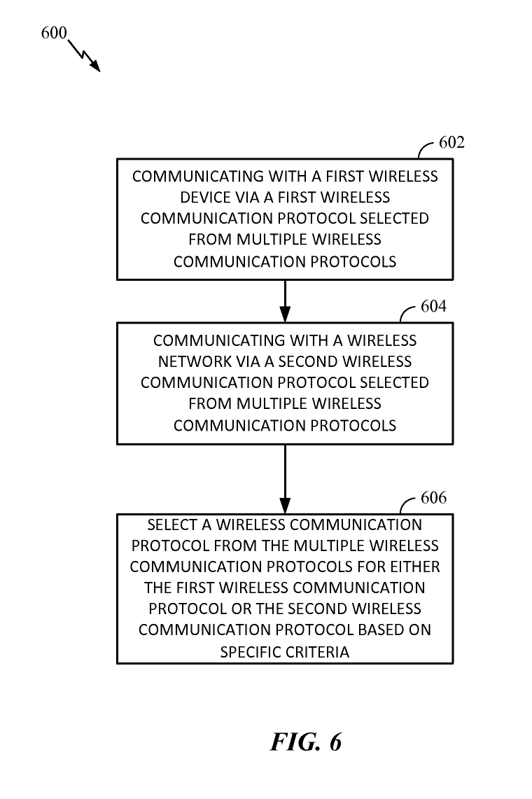

FIG. 6 is a process flow diagram illustrating a method 600 of using a remote control to communicate with a device using various wireless communication protocols, according to an aspect of the present disclosure.

As shown in FIG. 6, at block 602 a device communicates with another wireless device via a first wireless communication protocol selected from multiple wireless communication protocols. Furthermore, at block 604 the device communicates with a wireless network via a second wireless communication protocol selected from multiple wireless communication protocols. Additionally, at block 606, the device selects a wireless protocol from the plurality of wireless communication protocols for either the first wireless communication protocol or the second wireless communication protocol based on specific criteria.

In one configuration each wireless communication protocol has a different physical layer address. Still, each wireless communication protocol may use the same upper layer address (i.e., network layer). Furthermore, the device may dynamically select between the wireless communication protocols. The selection may be based on a battery level of a device, communication needs, data size, and/or other needs. Moreover, the device may disable a wireless communication protocol when a power usage of the wireless communication protocol is greater than a threshold and the battery level of the device is less than a dynamic threshold. The dynamic threshold may be configured by an application that is running on the device.

Additionally, in one configuration, the device is configured with a preferred list of communication protocols. Accordingly, in this configuration, wireless communication protocols are selected based on the preferred list. For example, in some cases, Bluetooth may be preferred over Zigbee and WiFi may be preferred over another long rage protocol. Thus, in this example, for short range communications, the device may first select Bluetooth and then select Zigbee.

Additionally, or alternatively, the device may broadcast a list of supported wireless communication protocols. Based on the broadcasted list, an apparatus can select one of the supported wireless communication protocols for communications with the device.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The foregoing description of one or more embodiments or aspects of the present disclosure has been presented for the purposes of illustration and description. It is not intended to be exhaustive or to limit the disclosure or the invention to the precise form disclosed. Many modifications and variations are possible in light of the above teaching. Although the present disclosure and invention has been described in connection with certain embodiments, it is to be understood that modifications and variations may be utilized without departing from the principles and scope of the disclosure or invention, as those skilled in the art will readily understand. Accordingly, such modifications would be practiced within the scope of the disclosure and invention, and within the scope of the following claims or within the full range of equivalents of the claims.

Further, the attached claims are presented merely as one aspect of the present invention. No disclaimer is intended, expressed, or implied for any claim scope of the present invention through the inclusion of this or any other claim language that is presented herein or may be presented in the future. Any disclaimers, expressed or implied, made during prosecution of the present application regarding the claims presented, changes made to the claims for clarification, or other changes made during prosecution, are hereby expressly disclaimed for at least the reason of recapturing any potential disclaimed claim scope affected by presentation of specific claim language during prosecution of this and any related applications. Applicant reserves the right to file broader claims, narrower claims, or claims of different scope or subject matter, in one or more continuation or divisional applications in accordance within the full breadth of the present disclosure, and the full range of doctrine of equivalents of the present disclosure, as recited in this specification.

What is claimed is:

1. A system, comprising:
a first wireless device;
a second wireless device connected to the first wireless device via a first wireless communication protocol of a plurality of wireless communication protocols, the second wireless device comprising at least a digital filter and an analog filter for filtering communications received via the first wireless communication protocol; and
a wireless network connected to the second wireless device via a second wireless communication protocol of the plurality of wireless communication protocols, the second wireless device dynamically selecting a wireless communication protocol from the plurality of wireless communication protocols for either the first wireless communication protocol or the second wireless communication protocol based on specific criteria.

2. The system of claim 1, in which the specific criteria is received from the first wireless device.

3. The system of claim 2, in which the specific criteria is based on a battery level, a power usage of the wireless communication protocol, a type of communication, a type of action to be performed, or a combination thereof.

4. The system of claim 1, in which the specific criteria is a battery level of the second wireless device such that a specific wireless communication protocol is selected when the battery level of the second wireless device is less than a threshold configured by an application of the second wireless device.

5. The system of claim 1, in which the specific criteria is based on an output of at least the digital filter, the analog filter, or a combination thereof.

6. The system of claim 1, in which the plurality of wireless communication protocols comprises a long-range wireless communication protocol and a close-range wireless communication protocol.

7. The system of claim 6, in which the long-range wireless communication protocol comprises WiFi and the close-range wireless communication protocol comprises ZigBee or Bluetooth.

8. The system of claim 1, in which the first wireless communication protocol is a same wireless protocol as the second wireless communication protocol.

9. The system of claim 1, in which the first wireless communication protocol is a different wireless protocol as the second wireless communication protocol.

10. The system of claim 1, in which the second wireless device comprises a preferred list of wireless communication protocols for communicating with the first wireless device, and the first wireless communication protocol is selected based on the preferred list of wireless communication protocols.

11. The system of claim 1, in which the first wireless device is a remote control.

12. A method for wireless communication, comprising:
communicating, via a first wireless device, with a second wireless device via a first wireless communication protocol of a plurality of wireless communication protocols;
communicating, via the first wireless device, with a wireless network via a second wireless communication protocol of the plurality of wireless communication protocols, communications via the first wireless communication protocol and the second wireless communication protocol being filtered via at least a digital filter and an analog filter; and
selecting, at the first wireless device, a wireless communication protocol from the plurality of wireless communication protocols for either the first wireless communication protocol or the second wireless communication protocol based on specific criteria.

13. The method of claim 12, in which the specific criteria is received from the second wireless device.

14. The method of claim 13, in which the specific criteria is based on a battery level, a power usage of the wireless communication protocol, a type of communication, a type of action to be performed, or a combination thereof.

15. The method of claim 12, in which the specific criteria is a battery level of the first wireless device such that a specific wireless communication protocol is selected when the battery level of the first wireless device is less than a threshold configured by an application of the first wireless device.

16. The method of claim 12, in which the specific criteria is based on an output of at least the digital filter, the analog filter, or a combination thereof.

17. The method of claim 12, in which the plurality of wireless communication protocols comprises a long-range wireless communication protocol and a close-range wireless communication protocol.

18. The method of claim 17, in which the long-range wireless communication protocol comprises WiFi and the close-range wireless communication protocol comprises ZigBee or Bluetooth.

19. The method of claim 12, in which the first wireless communication protocol is a same wireless protocol as the second wireless communication protocol.

20. The method of claim 12, in which the first wireless communication protocol is a different wireless protocol as the second wireless communication protocol.

21. The method of claim 12, in which at least the first wireless communication protocol is selected based on a preferred list of wireless communication protocols.

22. The method of claim 12, in which the first wireless device is a remote control.
